(19) United States
(12) Patent Application Publication
(10) Pub. No.: US 2007/0172099 A1
(43) Pub. Date: Jul. 26, 2007

(54) Scalable face recognition method and apparatus based on complementary features of face image

(75) Inventors: Gyu-tae Park, Anyang-si (KR); Jong-ha Lee, Hwaseong-si (KR); Seok-cheol Kee, Seoul (KR); Won-jun Hwang, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/581,491

(22) Filed: Oct. 17, 2006

(30) Foreign Application Priority Data
Jan. 13, 2006 (KR) 10-2006-0004144

(51) Int. Cl. G06K 9/00; G06K 9/62; G06K 9/68

(52) U.S. Cl. 382/118; 382/224; 382/218

(57) ABSTRACT

A scalable face recognition method and apparatus using complementary features. The scalable face recognition apparatus includes a multi-analysis unit which analyzes a plurality of features of an input face image using a plurality of feature analysis techniques separately, compares the features of the input face image with a plurality of features of a reference image; and provides similarities as the results of the comparison, a fusion unit which fuses the similarities, and a determination unit which classifies the input face image according to a result of the fusion performed by the fusion unit.

### CROSS-REFERENCE TO RELATED APPLICATIONS

This application claims priority from Korean Patent Application No. 10-2006-0004144 filed on Jan. 13, 2006 in the Korean Intellectual Property Office, the disclosure of which is incorporated herein by reference in its entirety.

### BACKGROUND OF THE INVENTION

1. Field of the Invention

The present invention relates to a face recognition method and apparatus and, more particularly, to a scalable face recognition method and apparatus based on complementary features.

2. Description of the Related Art

With the development of the information society, the importance of identification technology to identify individuals has rapidly grown, and more research has been conducted on biometric technology for protecting computer-based personal information and identifying individuals using the characteristics of the human body. In particular, face recognition, which is a type of biometric technique, uses a non-contact method to identify individuals, and is thus deemed more convenient and more competitive than other biometric techniques such as fingerprint recognition and iris recognition which require users to behave in a certain way to be recognized. Face recognition is a core technique for multimedia database searching, and is widely used in various application fields such as moving picture summarization using face information, identity certification, human computer interface (HCI) image searching, and security and monitoring systems.

However, face recognition may provide different results for different internal environments such as different user identities, ages, races, and facial expressions, and jewelry and for different external environments such as different poses adopted by users, different external illumination conditions, and different image processes. In other words, the performance of conventional face recognition techniques involving the analysis of only one type of features is likely to considerably change according to the environment to the face recognition techniques are applied. Therefore, it is necessary to develop face recognition techniques that are robust against variations in the environment to which the face recognition techniques are applied.

### BRIEF SUMMARY

An aspect of the present invention provides a method and apparatus to improve the performance of face recognition by analyzing a face image using a plurality of feature analysis techniques and fusing similarities obtained as the results of the analysis.

According to an aspect of the present invention, there is provided a face recognition method. The face recognition method includes: analyzing a plurality of features of an input face image using a plurality of feature analysis techniques separately, comparing the features of the input face image with a plurality of features of a reference image, and providing similarities as the results of the comparison; fusing the similarities; and classifying the input face image according to a result of the fusing.

According to another aspect of the present invention, there is provided a face recognition apparatus. The face recognition apparatus includes: a multi-analysis unit which analyzes a plurality of features of an input face image using a plurality of feature analysis techniques separately, compares the features of the input face image with a plurality of features of a reference image; and provides similarities as the results of the comparison, a fusion unit which fuses the similarities, and a determination unit which classifies the input face image according to the result of the fusion performed by the fusion unit.

According to another aspect of the present invention, there is provided a face recognition method. The face recognition method includes: separately subjecting features of a query face image to a plurality of feature analysis techniques; identifying similarities between the features of the query face image and features of a reference face image; fusing the identified similarities to yield a fused similarity; and classifying the query face image by comparing the fused similarity to a specified threshold and deciding whether accept or reject the query image based on the comparing.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a face recognition apparatus according to an embodiment of the present invention;

FIG. 2 is a block diagram of an image input unit illustrated in FIG. 1;

FIG. 3 is a block diagram of a normalization unit illustrated in FIG. 1;

FIG. 4 is a block diagram of a multi-analysis unit illustrated in FIG. 1;

FIG. 5 is a block diagram of a classifier according to an embodiment of the present invention;

FIG. 6 is a block diagram of a discrete Fourier transform (DFT)-based linear discriminant analysis (LDA) unit illustrated in FIG. 5;

FIG. 7 is a block diagram of a classifier according to an embodiment of the present invention;

FIGS. 8A and 8B are tables presenting sets of Gabor filters according to an embodiment of the present invention;

FIG. 9 is a block diagram of an LDA unit and a similarity calculation unit of the classifier illustrated in FIG. 7;

FIG. 10 is a block diagram for explaining a method of fusing similarities according to an embodiment of the present invention;

FIG. 11 is a graph presenting experimental results for choosing one or more Gabor filters from a plurality of Gabor filters according to an embodiment of the present invention;

FIG. 12 is a diagram illustrating an example of a basic local binary pattern (LBP) operator;

FIGS. 13A and 13B are illustrating circular neighbor sets for different (P, R);

FIG. 14 is a diagram illustrating nine uniform rotation invariant binary patterns;

FIG. 15 is a block diagram of a classifier according to another embodiment of the present invention;

FIG. 16 is a block diagram of a base vector generation unit illustrated in FIG. 15; and

FIG. 17 is a flowchart illustrating a face recognition method according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

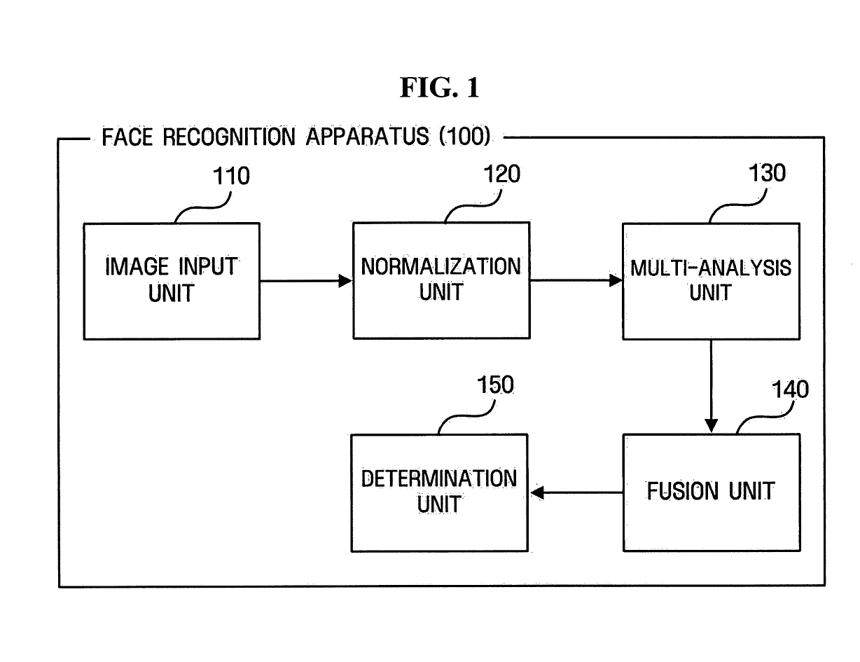

FIG. 1 is a block diagram of a face recognition apparatus 100 according to an embodiment of the present invention. Referring to FIG. 1, the face recognition apparatus 100 includes an image input unit 110, a face image extraction unit 120, a multi-analysis unit 130, a similarity fusion unit 140, and a determination unit 150.

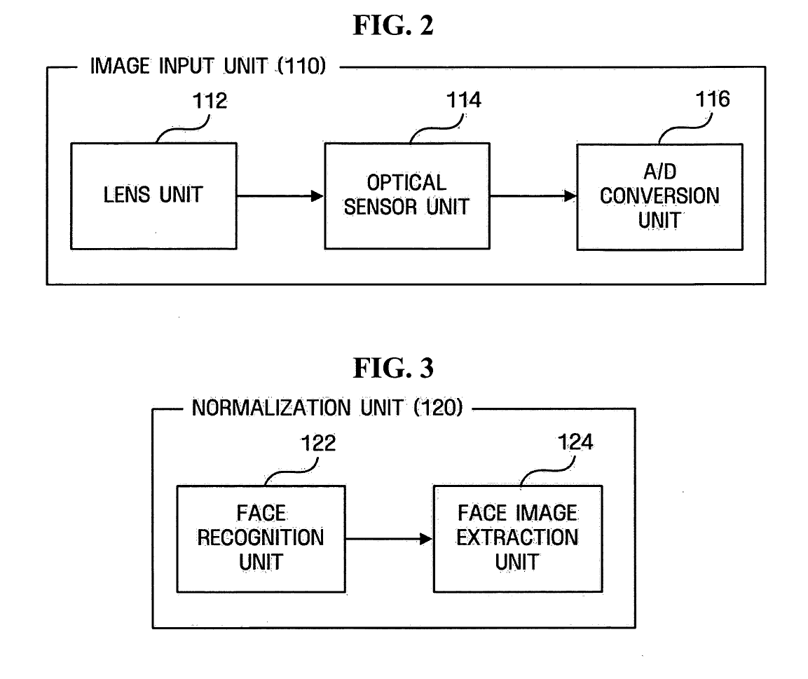

The image input unit 110 receives an input image comprising a face image, converts the input image into pixel value data, and provides the pixel value data to the normalization unit 120. To this end, referring to FIG. 2, the image reception unit 110 includes a lens unit 112 through which the input image is transmitted, an optical sensor unit 114 which converts an optical signal corresponding to the input image transmitted through the lens unit 112 into an electrical signal (i.e., an image signal), and an analog-to-digital (A/D) conversion unit 116 which converts the electrical signal into a digital signal. The optical sensor unit 114 performs a variety of functions such as an exposure function, a gamma function, a gain control function, a white balance function, and a color matrix function, which are normally performed by a camera. The optical sensor unit 114 may be, by way of non-limiting examples, a charge coupled device (CCD) or a complementary metal oxide semiconductor (CMOS) device. The image reception unit 110 may obtain image data, which is converted into pixel value data, from a specified storage medium and provide the image data to the normalization unit 120.

The normalization unit 120 extracts a face image from the input image, and extracts a plurality of fiducial points (i.e., fixed points for comparison) from the face image. Referring to FIG. 3, the normalization unit 120 includes a face recognition unit 122 and a face image extraction unit 124.

The face recognition unit 122 detects a specified region in the input image, which is represented as pixel value data. For example, the face recognition unit 122 may detect a portion of the input image comprising the eyes and use the detected portion to extract a face image from the input image.

The face image extraction unit 124 extracts a face image from the input image with reference to the detected portion provided by the face recognition unit 121. For example, if the face recognition unit 122 detects the positions of the left and right eyes rendered in the input image, the face image extraction unit 124 may determine the distance between the left and right eyes rendered in the input image. If the distance between the eyes rendered in the input image is 2D, the face image extraction unit 124 extracts a rectangle whose left side is D distant apart from the left eye, whose right side is D distant apart from the right eye, whose upper side is 1.5*D distant apart from a line drawn through the left and right eyes, and whose lower side is 2*D distant apart from the line drawn through the left and right eyes from the input image as a face image. In this manner, the face image extraction unit 124 can effectively extract a face image that includes all the facial features of a person (e.g., the eyebrows, the eyes, the nose, and the lips) from the input image while being less affected by variations in the background of the input image or in the hairstyle of the person. However, it is to be understood that this is merely a non-limiting example. Indeed, the face image extraction unit 122 may extract a face image from the input image using a method other than the one set forth herein.

The structure and operation of the normalization unit 120 described above with reference to FIG. 3 is merely a non-limiting example. Indeed, the normalization unit 120 may perform various pre-processing operations needed to analyze features of a face image. For example, a plurality of input images may have different brightnesses according to their illumination conditions, and a plurality of portions of an input image may also have different brightnesses according to their illumination conditions. Illumination variations may make it difficult to extract a plurality of features from a face image. Therefore, in order to reduce the influence of illumination variations, the normalization unit 120 may obtain a histogram by analyzing the distribution of pixel brightnesses in a face image, and smooth the histogram around the pixel brightness with the highest frequency.

The multi-analysis unit 130 extracts one or more features from an input face image using a plurality of feature analysis techniques separately, and calculates similarities between the extracted features and one or more features extracted from a reference face image. Here, the reference face image is an image to be compared with a query image to be tested, i.e., the input face image.

The multi-analysis unit 130 can provide multiple similarities for a single face image by using a plurality of feature analysis techniques. The multi-analysis unit 130 may include a plurality of classifiers 134-1 through 134-N (hereinafter collectively referred to the classifiers 134) which analyze features of a face image using different feature analysis techniques and calculates similarities, and a face image resizing unit 132 which resizes a face image provided by the normalization unit 120, thereby providing a plurality of face images that slightly differ from one another in at least one of resolution, size, and eye distance (ED) and are appropriate to be processed by the classifiers 134, respectively. A plurality of face image processed by the classifiers 134 may have different resolutions, sizes, or EDs. For example, the multi-analysis unit 130 may include a first recognition unit which analyzes global features of an input face image using low-resolution face images, a second recognition unit which analyzes local features of the input face image using medium-resolution face images, and a third recognition unit which analyzes skin texture features of the input face image using high-resolution face images.

When face recognition is performed by applying a plurality of feature analysis techniques to a single face image, similarities obtained as the results of the applying may be complementary to one another. For example, similarities obtained using low-resolution face images are relatively robust against variations in the facial expression or blurriness, and similarities obtained using high-resolution face images enable analysis of detailed facial features. Therefore, it is possible to perform more precise face recognition by integrating the similarities obtained using low-resolution face images and the similarities obtained using high-resolution face images. The structure and operation of each of the classifiers 134 included in the multi-analysis unit 130 will be described after describing the structures and operations of the fusion unit 140 and the determination unit 150.

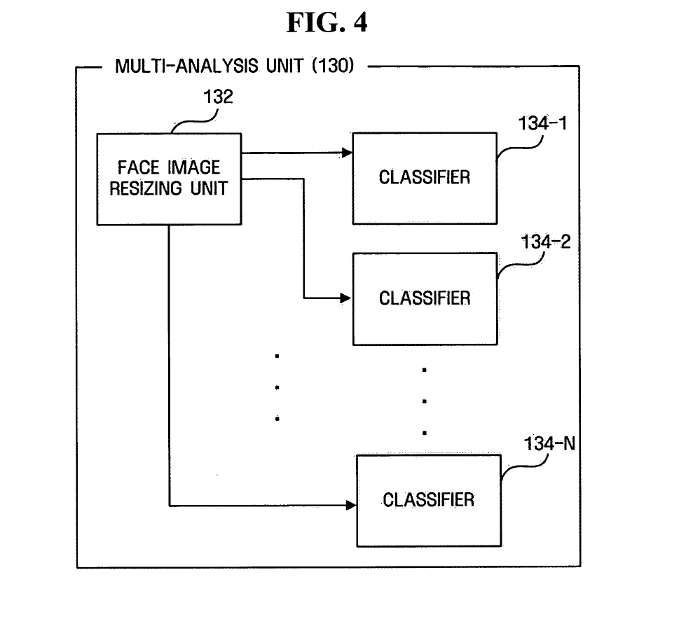

FIG. 4 illustrates the multi-analysis unit 130 as including a single face image resizing unit 132. However, it is to be understood that this is merely a non-limiting example. For example, the multi-analysis unit 130 may include a plurality of face image resizing units respectively corresponding to the classifiers 134. Alternatively, the face image resizing unit 132 may be included in the normalization unit 120.

The fusion unit 140 fuses the similarities provided by the multi-analysis unit 130, thereby obtaining a final similarity for the face image included in the input image. The fusion unit 140 may use various similarity fusion methods to obtain the final similarity.

In detail, the fusion unit 140 may average the similarities provided by the multi-analysis unit 130, and provide the result of the averaging as the final similarities, as indicated by Equation (1):

$$S = \frac{1}{N} {\sum }_{i = 1}^{N} {s}_{i} . \qquad ( 1 )$$

Here, sᵢ represents each of the similarities provided by the multi-analysis unit 130, N represents the number of similarities provided by the multi-analysis unit 130, i.e., the number of classifiers 134, and S represents the final similarity obtained by the fusion unit 140.

Alternatively, the multi-analysis unit 130 may obtain the final similarity by calculating a weighted sum of the similarities provided by the multi-analysis unit 130, as indicated by Equation (2):

$$S = {\sum }_{i = 1}^{N} {w}_{i} {s}_{i} . \qquad ( 2 )$$

Here, sᵢ represents each of the similarities provided by the multi-analysis unit 130, wᵢ represents a weight value applied to each of the similarities provided by the multi-analysis unit 130, N represents the number of similarities provided by the multi-analysis unit 130, i.e., the number of classifiers 134, and S represents the final similarity obtained by the fusion unit 140. The weight value wᵢ may be set according to the environment to which the face recognition apparatus 100 is applied in such a manner that a weight value allocated to a score obtained by a classifier 134 that is expected to achieve high performance is higher than a weight value allocated to a score obtained by a classifier 134 that is expected to achieve low performance. In other words, the weight value wᵢ may be interpreted as reliability of each of the classifiers 134.

The fusion unit 140 may use an equal error rate (ERR)-based weighted sum method. The ERR of a classifier 134 is an error rate occurring when false rejection rate and false acceptance rate that are obtained by performing face recognition on an input face image using the classifier 134 become equal.

The higher the performance of a classifier 134 is, the lower the EER of the classifier 134 becomes. Thus, the inverse of the ERR of a classifier 134 can be used as a weight value for the classifier 134. In this regard, the weight value wi in Equation (2) can be substituted for by

$$\frac{1}{{EER}_{i}}$$

where EERi represents the ERR of each of the classifiers 134. The ERR EERi can be determined according to training results obtained in advance using each of the classifiers 134.

Alternatively, the fusion unit 140 may fuse the similarities provided by the multi-analysis unit 130 using a likelihood ratio, and this will hereinafter be described in detail.

If it is assumed that a plurality of scores respectively output by the classifiers 134 are S₁ through Sₙ. When the scores S₁ through Sₙ are input, it must be determined whether the scores S₁ through Sₙ originate from a query image-reference image pair comprising a query image and a reference image that render the same object or from a query image-reference image pair comprising a query image and a reference image that render different objects. For this, hypotheses H₀ and H₁ can be established as indicated by Equation (3):
H₀:S₁, . . . , Sₙ˜p(s₁, . . . sₙ|diff), (3)
H₁:S₁, . . . , Sₙ˜p(s₁, . . . sₙ|same)
Here, p(s₁, . . . , sₙ|diff) represents the density of similarities output by the classifiers 134 when the scores S₁ through Sₙ are determined to originate from a query image-reference image pair comprising a query image and a reference image that render different objects, and p(S₁, . . . , sₙ|same) represents the density of similarities output by the classifiers 134 when the scores S₁ through Sₙ are determined to originate from a query image-reference image pair comprising a query image and a reference image that render the same object. If the densities p(s₁, . . . , sₙ|diff) and p(s₁, . . . , sₙ|same) are known, a log-likelihood ratio test may result in the highest verification rate that satisfies a given false acceptance rate according to the Neyman-Pearson Lemma. The Neyman-Pearson Lemma is taught by T. M. Cover and J. A. Thomas in an article entitled “Elements of Information Theory.” The log-likelihood ratio test may be represented by Equation (4):

$$log \frac{p ( {s}_{1} , … , {s}_{n} \vert same )}{p ( {s}_{1} , … , {s}_{n} \vert diff )} > < 0. \qquad ( 4 )$$

Even if the densities p(s₁, . . . , sₙ|diff) and p(s₁, . . . , sₙ|same) are unknown, the densities p(s₁, . . . , sₙ|diff) and p(s₁, . . . , sₙ|same) can be estimated using similarities obtained from training data comprising a plurality of query image-reference image pairs.

In order to estimate the densities p(s₁, . . . , sₙ|diff) and p(s₁, . . . , sₙ|same), a nonparametric density estimation method such as a Parzen density estimation method can be used. The Parzen density estimation method is taught by E. Parzen in an article entitled “On Estimation of a Probability Density Function and Mode.” A method of integrating a plurality of classifiers using the Parzen density estimation method is taught by S. Prabhakar and A. K. Jain in an article entitled “Decision-Level Fusion in Fingerprint Verification.” According to the present embodiment, a parametric density estimation may be used due to computational complexity and overfitting of a nonparametric density estimation method.

If {Sᵢ}ᵢ₌₁ⁿ in hypothesis H₀ is modeled using independent Gaussian random variables, the density p(s₁, . . . , sₙ|diff) can be defined by Equation (5):
p(s₁, . . . , sₙ|diff=ΠN(sᵢ;m_{diff,i},σ_{diff,i}) (5)
Here, m_{diff,i} is the mean of similarities obtained by an i-th classifier 134 using a plurality of query image-reference image pairs, each query image-reference image pair comprising a query image and a reference image which render different objects, and σ_{diff,i} is the standard deviation of the similarities. The mean m_{diff,i} and the standard deviation σ_{diff,i} are determined through experiments conducted in advance.

A Gaussian density function N(sᵢ;m, σ) in Equation (5) can be indicated by Equation (6):

$$N ( {s}_{i} ; m , σ ) = \frac{1}{\sqrt{2 π} σ} exp \{ \frac{{( {s}_{i} - m )}^{2}}{2 {σ}^{2}} \} . \qquad ( 6 )$$

Likewise, if {Sᵢ}ᵢ₌₁ⁿ in hypothesis H₁ is modeled using independent Gaussian random variables, the density p(s₁, . . . , sₙ same) can be defined by Equation (7):
p(s₁, . . . , sₙ|same)=ΠN(sᵢ;m_{same,i},σ_{same,i}) (7)
Here, m_{same,i} is the mean of similarities obtained by the i-th classifier 134 using a plurality of query image-reference image pairs, each query image-reference image pair comprising a query image and a reference image which render the same object, and σ_{same,i} is the standard deviation of the similarities. The mean m_{same,i} and the standard deviation σ_{same,i} are determined through experiments conducted in advance.

A Gaussian density function N(sᵢ;m, σ) in Equation (7) can be defined by Equation (6).

Accordingly, the fusion unit 140 can fuse the similarities provided by the multi-analysis unit 130 using a log-likelihood ratio, as indicated by Equation (8):

$$\begin{matrix}S = log \frac{{\prod }_{i = 1}^{n} N ( {S}_{i} ; {m}_{same , i} , {σ}_{same , i} )}{{\prod }_{i = 1}^{n} N ( {S}_{i} ; {m}_{diff , i} , {σ}_{diff , i} )} \\ = {\sum }_{i = 1}^{n} ( \frac{{( {S}_{i} - {m}_{diff , i} )}^{2}}{2 {σ}_{diff , i}^{2}} - \frac{{( {S}_{i} - {m}_{same , i} )}^{2}}{2 {σ}_{same , i}^{2}} ) + c .\end{matrix} \qquad ( 8 )$$

Here, S represents the final score output by the fusion unit 140, and c is a constant. The constant c does not affect the performance of face recognition, and can thus be excluded from the calculation of the final score S.

The similarity fusion methods described above with reference to Equations (1) through (8) are merely non-limiting examples and other methods are contemplated.

Referring to FIG. 1, the determination unit 150 classifies the input image using the final similarity provided by the fusion unit 140. In detail, if the final similarity provided by the fusion unit 140 is higher than a specified critical value, the determination unit 150 may determine that a query face image to render the same person as that of a target face image, and decide to accept the query face image. Conversely, if the final similarity provided by the fusion unit 140 is lower than the predefined critical value, the determination unit 150 may determine the query face image renders a different person from the person rendered in the target face image, and decide to reject the query face image. Here, the greater the predefined critical value is, the higher the false rejection rate becomes. Conversely, the smaller the predefined critical value is, the lower the false accept rate becomes. Therefore, the predefined critical value may be determined in advance by statistically experimenting with the performance of the face recognition apparatus 100 and an environment where the face recognition apparatus 100 is to be used.

FIG. 1 illustrates the fusion unit 140 and the determination unit 150 as being separate blocks. However, the fusion unit 140 may be integrated into the determination unit 150.

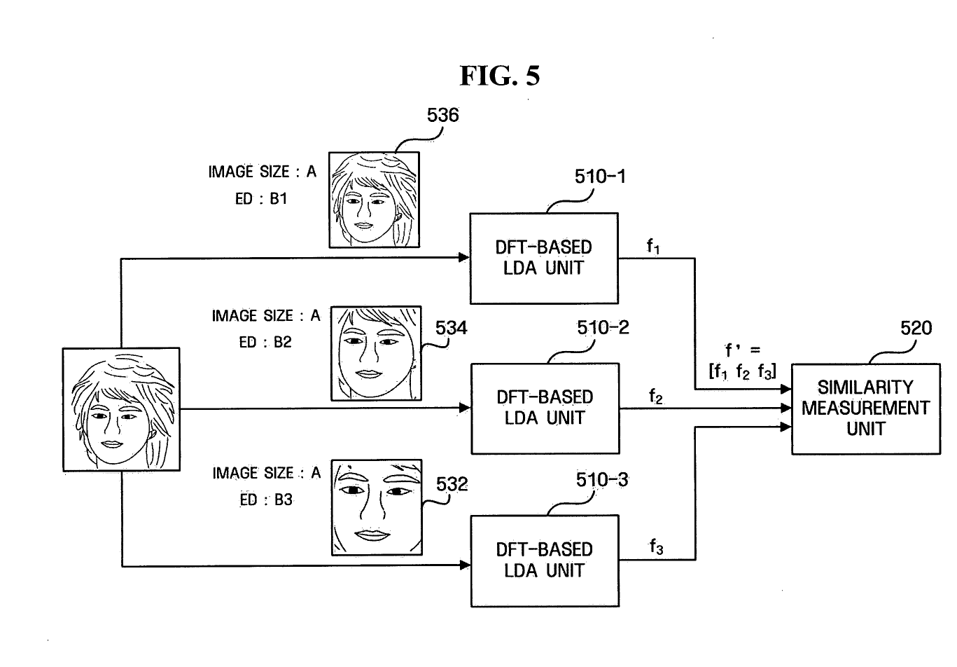

Feature analysis algorithms used by the classifiers 134 included in the multi-analysis unit 130 will hereinafter be described in detail with reference to FIGS. 5 through 9. The multi-analysis unit 130 may analyze global features (such as contours of a face), local features (such as detailed features of a face), and skin texture features (such as detailed information regarding specified areas on a face) of a face image. The structure and operation of each of the classifiers 134 will hereinafter be described in detail focusing more on analysis of global features, local features, and skin texture features of a face image.

1. Analysis of Global Features of Face Image

According to the present embodiment, a discrete Fourier transform (DFT)-based linear discriminant analysis (LDA) operation is performed in order to analyze global features of a face image. The structure of a classifier 134 that performs the DFT-based LDA operation is illustrated in FIG. 5.

FIG. 5 is a block diagram of a classifier according to an embodiment of the present invention. Referring to FIG. 5, the classifier includes one or more DFT-based LDA units 510-1 through 510-3 (hereinafter collectively referred to as the DFT-based LDA units 510) and a similarity measurement unit 520. FIG. 5 illustrates a classifier comprising only three DFT-based LDA units 510. However, it is to be understood that this is merely a non-limiting example.

Referring to FIG. 5, a plurality of face images 536, 534, and 532 respectively input to the DFT-based LDA units 510 are of the same size, i.e., A, but have different EDs. The face images 536, 534, and 532 are provided by the face image resizing unit 132 illustrated in FIG. 4. Principal facial elements such as the eyes, the nose, and the lips can be analyzed using the face image 532 having the longest ED, i.e., B3. Marginal facial elements such as hairstyle, the ears, and the jaw can be analyzed using the face image 536 having the shortest ED, i.e., B1. Since the face image 534 having the medium ED, i.e., B2, appropriately renders both the principal and marginal facial elements, the face image 534 can result in higher performance than the face images 532 and 536 when being applied to independent face model experiments. In the actual experiments to realize the present invention, the size A was set to 46*56, and the EDs B3, B2, and B1 were respectively set to 31, 25, and 19.

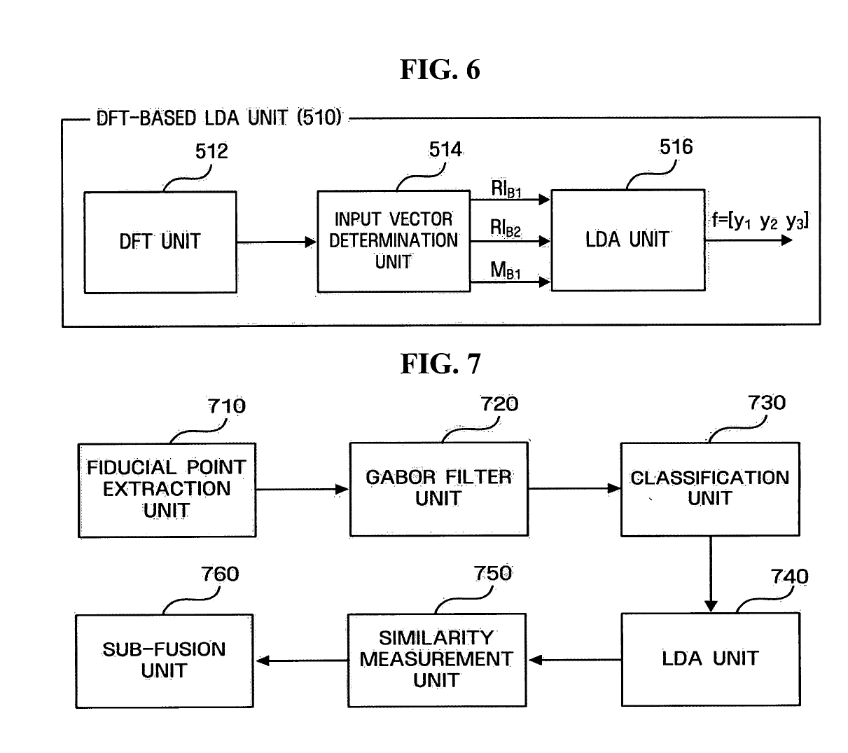

Referring to FIG. 6, each of the DFT-based LDA units 510 includes a DFT unit 512, an input vector determination unit 514, and an LDA unit 516.

The DFT unit 512 performs DFT on an input face image. The DFT unit 512 may perform 2-dimensional (2D)-DFT, as indicated by Equation (9):
F(u,v)=Fᵣₑ(u,v)+j·Fᵢₘ(u,v) (9)
Here, Fᵣₑ(u,v) and Fᵢₘ(u,v) respectively represent a real component and an imaginary component of the result of the 2D-DFT performed by the DFT unit 512, and variables u and v represent frequencies. The variables u and v are defined by Equation (10):
0≦u≦(X−1), (10)
0≦v≦(Y−1)
Here, X and Y represent the size of the input face image (X*Y).

Referring to FIG. 6, the input vector determination unit 514 provides an input vector by processing real and imaginary components RI of the result of the 2D-DFT performed by the DFT unit 512 and the magnitude M of the result of the 2D-DFT performed by the DFT unit 512 with a specified frequency band. The real and imaginary components RI and the magnitude M used by the input vector determination unit 514 are respectively represented by Equations (11) and (12):

$$\begin{matrix}RI ( u , v ) = [ {F}_{re} ( u , v ) {F}_{im} ( u , v ) ] ; and & ( 11 ) \\ M ( u , v ) = \vert F ( u , v ) \vert = {[ {F}_{re}^{2} ( u , v ) + {F}_{im}^{2} ( u , v ) ]}^{\frac{1}{2}} . & ( 12 )\end{matrix}$$

The input vector determination unit 514 can process the real and imaginary components RI and the magnitude M using a plurality of frequency bands. The input vector determination unit 514 may use a first frequency band B₁(=[B₁₁ B₁₂]), which is a narrow frequency band, and a second frequency band B₂(=[B₂₁ B₂₂]), which is a broad frequency band, to process the real and imaginary components RI and the magnitude M. Examples of the first and second frequency bands are presented in Table 1 below.

TABLE 1

| Bᵢⱼ(u,v) | j = 1 | j = 2 |
|---|---|---|
| First Frequency Band (i = 1) | $0 \leq u \leq \frac{X}{4} , 0 \leq v \leq \frac{Y}{4}$ | $\frac{3 X}{4} \leq u \leq X , 0 \leq v \leq \frac{Y}{4}$ |
| Second Frequency Band (i = 2) | $0 \leq u \leq \frac{X}{2} , 0 \leq v \leq \frac{Y}{2}$ | $\frac{X}{2} \leq u \leq X , 0 \leq v \leq \frac{Y}{2}$ |

The first frequency band can provide low-frequency information regarding a face model, for example, coarse facial geometric shapes. The second frequency band can enable analysis of detailed facial features comprising high-frequency information.

The input vector determination unit 514 may provide input vectors RI_{B1} and RI_{B2} for real and imaginary component domains and an input vector M_{B1} for a Fourier spectrum domain by applying the first and second frequency bands to the real and imaginary components RI and applying the first frequency band to the magnitude M. However, it is to be understood that this is merely a non-limiting example and that other frequency bands may be used.

The LDA unit 516 receives one or more input vectors provided by the input vector determination unit 514 and performs LDA on the received input vectors. Since the input vector determination unit 514 provides the LDA unit 516 with more than one input vector, the LDA unit 516 performs LDA on each of the input vectors provided by the input vector determination unit 514. For example, assuming that the input vectors provided by the input vector determination unit 514 are (RI_{B1}, RI_{B2}, M_{B1}), the LDA unit 516 performs LDA on each of the input vectors RI_{B1}, RI_{B2}, and M_{B1}, thereby obtaining three LDA results. The LDA results obtained by the LDA unit 516 may be provided as a single output vector f(=[y₁ y₂ y₃]), as illustrated in FIG. 6. FIG. 6 illustrates only one LDA unit 516. However, a plurality of LDA units 516 may be provided to process a plurality of input vectors, respectively.

Referring to FIG. 5, the similarity measurement unit 520 measures a similarity by comparing a plurality of output vectors respectively provided by the DFT-based LDA units 510 with an output vector obtained from a reference image. The output vector obtained from the reference image may be obtained in advance through training and may be stored in the similarity measurement unit 520. The similarity obtained by the similarity measurement unit 520 is provided to the fusion unit 140 illustrated in FIG. 1 and is fused with other similarities respectively provided by other classifiers 134. According to an embodiment of the present invention, a plurality of similarity measurement units may be provided for the respective DFT-based LDA units 510, and similarities respectively provided by the similarity measurement units may be provided to the fusion unit 140.

2. Analysis of Local Features of Face Image

According to the present embodiment, a Gabor LDA operation is performed in order to analyze local features of a face image. The structure of a classifier 134 that performs the Gabor LDA operation is illustrated in FIG. 7.

FIG. 7 is a block diagram of a classifier according to an embodiment of the present invention. Referring to FIG. 7, the classifier includes a fiducial point extraction unit 710, a Gabor filter unit 720, a classification unit 730, an LDA unit 740, a similarity measurement unit 750, and a sub-fusion unit 760.

The fiducial point extraction unit 710 extracts a specified number of fiducial points, to which a Gabor filter is to be applied, from an input face image. It may be determined which point in the input face image is to be determined as a fiducial point according to experimental results obtained using face images of various people. For example, a point in face images of different people which results in a difference of a predefined value or greater between Gabor filter responses may be determined as a fiducial point. An arbitrary point in the input face image may be determined as a fiducial point. However, according to the present embodiment, a point in the face images of different people which can result in Gabor filter responses that can help clearly distinguish the face images of the different people from one another is determined as a fiducial point, thereby enhancing the performance of face recognition.

The Gabor filter unit 720 obtains a response value from each of the fiducial points of the input face image by projecting a plurality of Gabor filters having different properties. The properties of a Gabor filter are determined according to one or more parameters of the Gabor filter. In detail, the properties of a Gabor filter are determined according to the orientation, scale, Gaussian width, and aspect ratio of the Gabor filter. A Gabor filter may be represented by Equation (13):

$$W ( x , y , λ , θ , σ , γ ) = {ⅇ}^{- \frac{{x}^{′2} + {y}^{2} {y}^{′2}}{2 {σ}^{2}}} {ⅇ}^{- j \frac{2 π}{λ} {x}^{′}} . \qquad ( 13 )$$

Here, x′=x cos θ+y sin θ, y′=−x sinθ+y cos θ, and θ, λ, σ, y, and j respectively represent the orientation, scale, Gaussian width, and aspect ratio of a Gabor filter, and an imaginary unit.

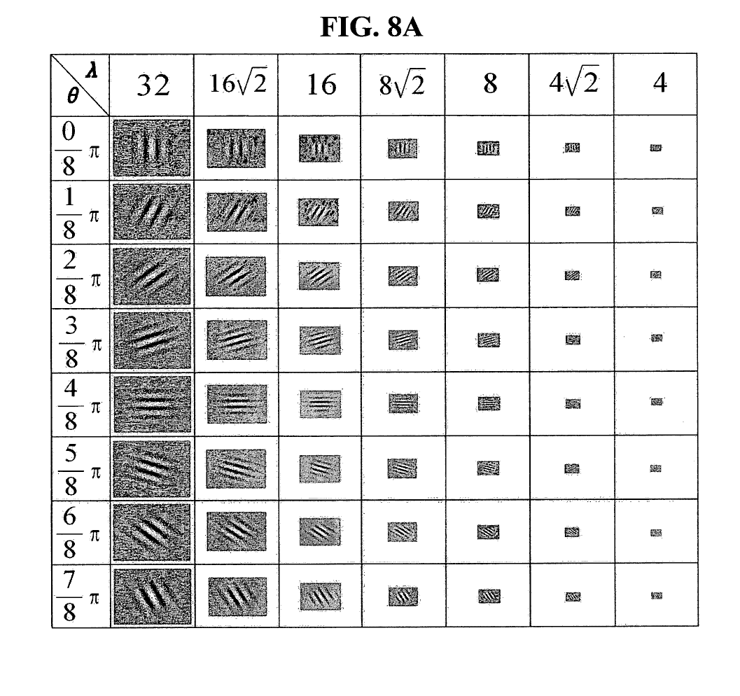

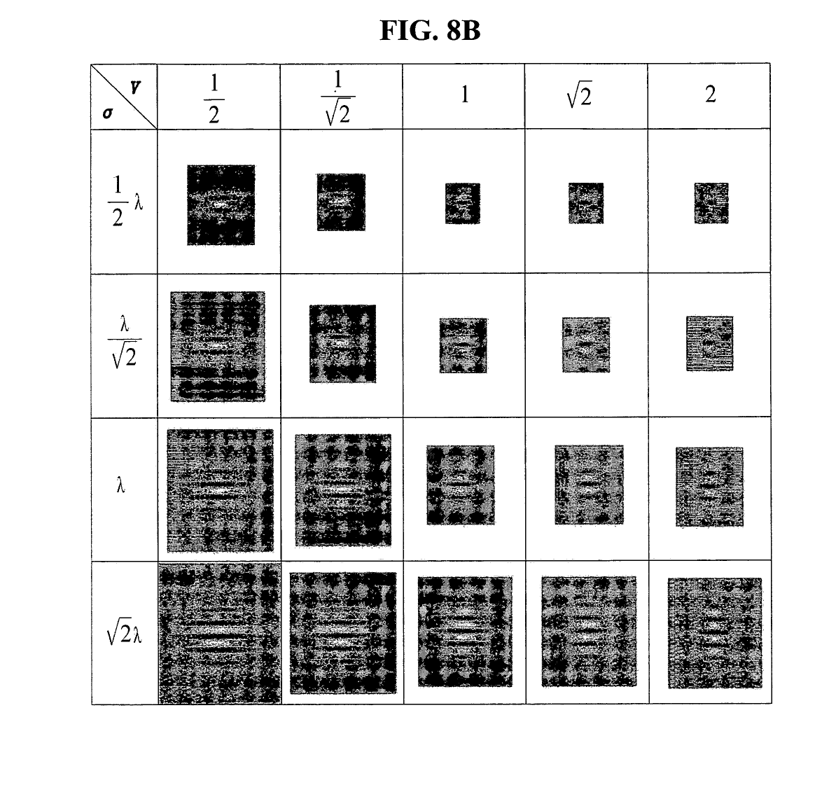

Sets of Gabor filters that can be applied to one or more fiducial points in a face image by the Gabor filter unit 720 will hereinafter be described in detail with reference to FIGS. 8A and 8B.

FIG. 8A is a table presenting a set of Gabor filters according to an embodiment of the present invention. Referring to FIG. 8A, the Gabor filters are classified according to their orientations and scales. In other words, a total of 56 Gabor filters can be obtained using 7 scales and 8 orientations.

According to the present embodiment, parameters such as Gaussian width and aspect ratio which are conventionally not considered are used to design Gabor filters, and this will hereinafter become more apparent by referencing FIG. 8B. Referring to FIG. 8B, a plurality of Gabor filters having an orientation θ of 4/8π and a scale λ of 32 are further classified according to their Gaussian widths and aspect ratios. In other words, a total of 20 Gabor filters can be obtained using 4 Gaussian widths and 5 aspect ratios.

Accordingly, a total of 1120 (56*20) Gabor filters can be obtained from the 56 Gabor filters illustrated in FIG. 8A by varying the Gaussian width and aspect ratio of the 56 Gabor filters, as illustrated in FIG. 8B.

The Gabor filter sets illustrated in FIGS. 8A and 8B are merely non-limiting examples, and the types of Gabor filters used by the Gabor filter unit 720 are not restricted to the illustrated sets. Indeed, the Gabor filters used by the Gabor filter unit 720 may have different parameter values from those set forth herein, or the number of Gabor filters used by the Gabor filter unit 720 may be different from the one set forth herein.

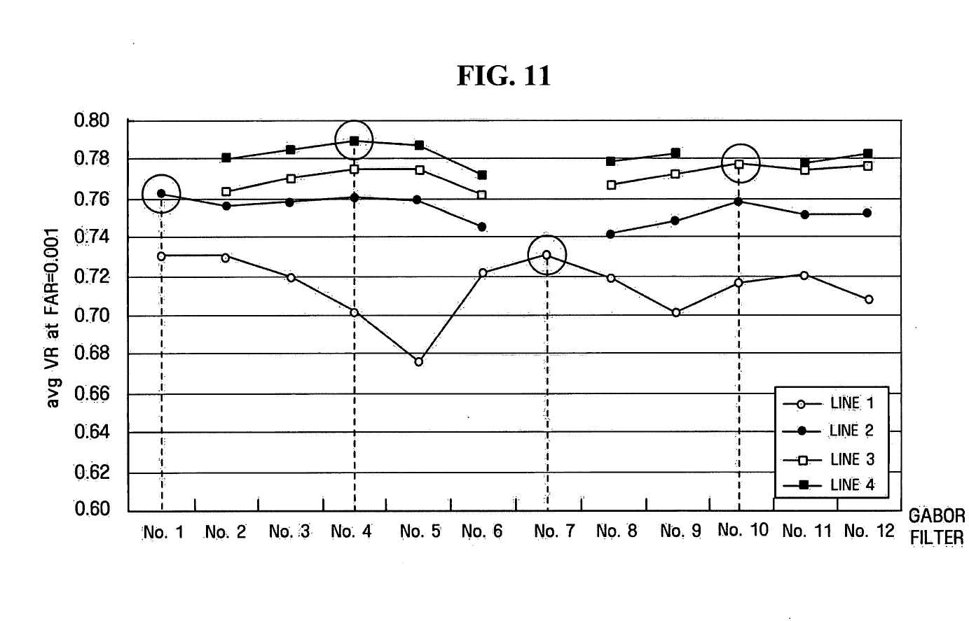

The greater the number of Gabor filters used by the Gabor filter unit 720, the heavier the computation burden on the face recognition apparatus 100. Thus, it is necessary to choose Gabor filters that are experimentally determined to considerably affect the performance of the face recognition apparatus 100, and allow the Gabor filter unit 720 to use only the chosen Gabor filters. This will be described later in further detail with reference to FIG. 11.

The response values obtained by the Gabor filter unit 720 represent the features of the input face image, and may be represented as a Gabor jet set J, as indicated by Equation (14):
S={J_{θ,λ,σ,γ}(x):θ∈{θ₁, . . . , θₖ}, λ∈{λ₁, . . . , λₗ}, σ∈{σ₁, . . . , σₘ}, (14)
γ∈{γ₁, . . . , γₙ}, x∈{x₁, . . . , xₐ}}
Here, θ, λ, σ, and γ respectively represent the orientation, scale, Gaussian width, and aspect ratio of a Gabor filter, and x represents a fiducial point.

The classification unit 730 classifies the response values obtained by the Gabor filter unit 130 into one or more response value groups. A single response value may belong to one or more response value groups.

The classification unit 730 may classify the response values obtained by the Gabor filter unit 720 into one or more response value groups according to the Gabor filter parameters used to generate the response values. For example, the classification unit 140 may provide a plurality of response value groups, each response value group comprising a plurality of response values corresponding to the same orientation and the same scale, for each of a plurality of pairs of Gaussian widths and aspect ratios used by the Gabor filter unit 130. For example, if the Gabor filter unit 720 uses 4 Gaussian widths and 5 aspect ratios, as illustrated in FIG. 8B, a total of 20 (4*5) Gaussian width-aspect ratio pairs can be obtained. If the Gabor filter unit 720 uses 8 orientations and 7 scales, as illustrated in FIG. 8A, 8 response value groups corresponding to the same orientation may be generated for each of the 20 Gaussian width-aspect ratio pairs, and 7 response value groups corresponding to the same scale may be generated for each of the 20 Gaussian width-aspect ratio pairs. In other words, 56 response value groups may be generated for each of the 20 Gaussian width-aspect ratio pairs, and thus, the total number of response value groups generated by the classification unit 730 equals 1120 (20*56). The 1120 response value groups may be used as features of the input face image.

Examples of the response value groups provided by the classification unit 730 are represented by Equation set (15):
C_{λ,σ,γ}^{(s)}={J_{θ,λ,σ,γ}(x):θ∈{θ₁, . . . , θₖ}, x∈{x₁, . . . , xₐ}} (15)
C_{θ,σ,γ}^{(o)}={J_{θ,λ,σ,γ}(x):λ∈{λ₁, . . . , λₗ}, x∈{x₁, . . . , x_{a}}}
Here, C represents a response value group, parenthesized superscript s and parenthesized superscript o indicate association with scale and orientation, respectively, and λ, σ, and γ respectively represent the orientation, scale, Gaussian width, and aspect ratio of a Gabor filter, and x represents a fiducial point.

The classification unit 730 may classify the response values obtained by the Gabor filter unit 720 in such a manner that a plurality of response values obtained from one or more predefined fiducial points can be classified into a separate response value group.

It is possible to reduce the number of dimensions of input values for LDA and thus facilitate the expansion of Gabor filters by classifying the response values obtained by the Gabor filter unit 720 into one or more response value groups in the aforementioned manner. For example, even when the number of features of a face image is increased by increasing the number of Gabor filters used by the Gabor filter unit 720 while varying Gaussian width and aspect ratio, the computation burden regarding LDA training can be reduced, and the efficiency of the LDA training can be enhanced by classifying the response values (i.e., the features of the input face image) obtained by the Gabor filter unit 720 into one or more response value groups and thus reducing the number of dimensions of input values.

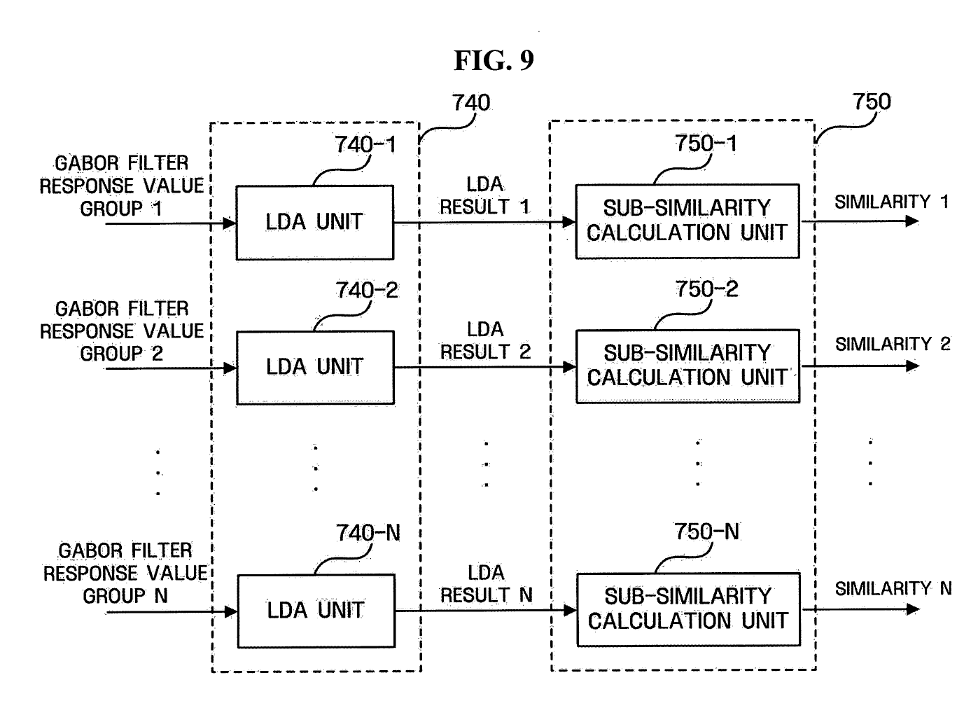

The LDA unit 740 receives the response value groups obtained by the classification unit 730, and performs LDA. In detail, the LDA unit 740 performs LDA on each of the received response value groups. For this, the LDA unit 740 may include a plurality of LDA units 740-1 through 740-N, as illustrated in FIG. 9. The LDA units 740-1 through 740-N respectively perform LDA on the received response value groups. Accordingly, the LDA unit 740 may output multiple LDA results for a single face image.

The similarity calculation unit 750 respectively compares the LDA results output by the LDA unit 150 with LDA training results obtained by performing LDA on a reference face image, and calculates a similarity for the LDA results output by the LDA unit 150 according to the results of the comparison.

In order to calculate a similarity for LDA results, the similarity calculation unit 750 may include a plurality of sub-similarity calculation units 750-1 through 750-N.

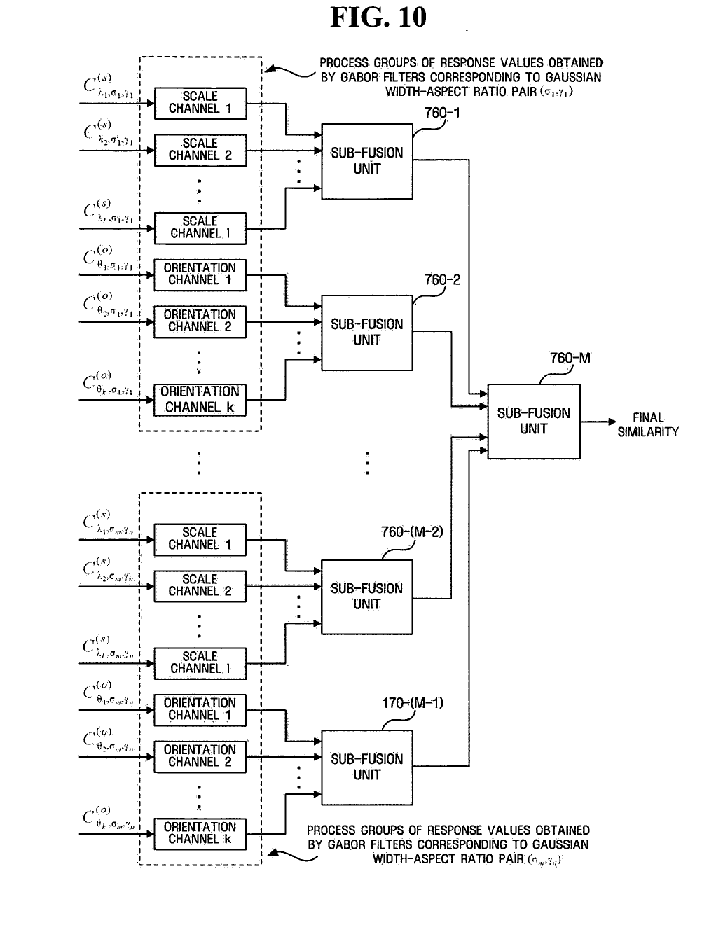

The sub-fusion unit 760 fuses similarities provided by the similarity calculation unit 750. The sub-fusion unit 760 may primarily fuse the similarities provided by the similarity calculation unit 750 in such a manner that similarities obtained using LDA results that are obtained by performing LDA on a plurality of response value groups provided by a plurality of Gabor filters having the same scale for each of a plurality of Gaussian width-aspect ratio pairs can be fused together and that similarities obtained using LDA results that are obtained by performing LDA on a plurality of response value groups provided by a plurality of Gabor filters having the same orientation for each of the Gaussian width-aspect ratio pairs can be fused together. Thereafter, the sub-fusion unit 760 may secondarily fuse the results of the primary fusing, thereby obtaining a final similarity. For this, more than one sub-fusion unit 760 may be provided, and this will hereinafter be described in detail with reference to FIG. 10.

FIG. 10 illustrates a plurality of channels. The channels illustrated in FIG. 10 may be interpreted as units into which the LDA units 740-1 through 740-N and the sub-similarity calculation units 750-1 through 750-N are respectively integrated. Referring to FIG. 10, each of the channels receives a response value group output by the classification unit 730, and outputs a similarity. In detail, referring to the channels illustrated in FIG. 10, those which respectively receive groups of response values output by a plurality of Gabor filters having the same scale are scale channels, and those which respectively receive groups of response values output by a plurality of Gabor filters having the same orientation are orientation channels. Each of the response value groups respectively received by the channels illustrated in FIG. 10 may be defined by Equations (14) and (15).

The scale channels and the orientation channels illustrated in FIG. 10 may be provided for each of a plurality of Gaussian width-aspect ratio pairs. Sub-fusion units 760-1 through 760-(M-1) primarily fuse similarities output by the scale channels provided for each of the Gaussian width-aspect ratio pairs, and primarily fuse similarities output by the orientation channels provided for each of the Gaussian width-aspect ratio pairs. Thereafter, a sub-fusion unit 760-M secondarily fuses the results of the primary fusing performed by the sub-fusion units 760-1 through 760-(M-1), thereby obtaining a final similarity.

Referring to FIG. 7, the sub-fusion unit 760 may use the same similarity fusion method as the fusion unit 140 illustrated in FIG. 1 to obtain the final similarity. If the sub-fusion unit 760 uses a weighted sum method, a primary fusion operation performed by the sub-fusion units 760-1 through 760-(M-1) illustrated in FIG. 10 and a secondary fusion operation performed by the sub-fusion unit 760-M illustrated in FIG. 10 may be respectively represented by Equations (16) and (17):

$$\begin{matrix}{S}_{σ , γ}^{( s )} = {\sum }_{λ} {S}_{λ , σ , γ}^{( s )} \cdot {w}_{λ , σ , γ}^{( s )} \\ {S}_{σ , γ}^{( o )} = {\sum }_{θ} {S}_{θ , σ , γ}^{( o )} \cdot {w}_{θ , σ , γ}^{( o )} ; and & ( 16 ) \\ {S}^{( total )} = {\sum }_{σ , γ} ( {S}_{σ , γ}^{( s )} \cdot {w}_{σ , γ}^{( s )} + {S}_{σ , γ}^{( o )} \cdot {w}_{σ , γ}^{( o )} ) . & ( 17 )\end{matrix}$$

Here, Srepresents similarity, wrepresents a weight value, parenthesized superscript s and parenthesized superscript o indicate association with scale and orientation, respectively, s^{(total)} represents a final similarity, and θ, λ, σ, and γ respectively represent the orientation, scale, Gaussian width, and aspect ratio of a Gabor filter.

The weight value w in Equations (16) and (17) may be set for each of a plurality of channels in such a manner that a similarity output by a channel that achieves a high recognition rate when being used to perform face recognition can be more weighted than a similarity output by a channel that achieves a low recognition rate when being used to perform face recognition. The weight value w may be experimentally determined.

The weight value w may be determined according to equal error rate (EER). The EER is an error rate occurring when false rejection rate and false acceptance rate obtained by performing face recognition become equal. The lower the EER is, the higher the recognition rate becomes. Thus, the inverse of EER may be used as the weight value w. In this case, the weight value w in Equations (16) and (17) may be substituted for by

$$\frac{k}{EER}$$

where k is a constant for normalizing the weight value w.

According to an embodiment of the present invention, the likelihood ratio-based similarity fusion method described above with reference to Equation (8) may be used for the primary fusion operation performed by the sub-fusion units 760-1 through 760-(M-1) illustrated in FIG. 10 and the secondary fusion operation performed by the sub-fusion unit 760-M.

According to an embodiment of the present invention, the classification unit 760 may classify a group of response values obtained from one or more predefined fiducial points of the fiducial points extracted by the fiducial extraction unit 710 into a separate response value group. In this case, these response values may be further classified into one or more response value groups according to their Gaussian width-aspect ratios, and the sub-fusion unit 760-M may perform a secondary fusion operation using these response values using Equation (18):

$${S}^{( total )} = {\sum }_{σ , γ} ( {S}_{σ , γ}^{( s )} \cdot {w}_{σ , γ}^{( s )} + {S}_{σ , γ}^{( o )} \cdot {w}_{σ , γ}^{( o )} + {S}_{σ , γ}^{( h )} \cdot {w}_{σ , γ}^{( h )} ) . \qquad ( 18 )$$

Here, S_{σ,γ}^{(h)} represents a similarity measured for the corresponding response values.

In order to realize a face recognition apparatus which can achieve high face tion rates and can reduce the number of Gabor filters used by the Gabor filter unit 720 ted in FIG. 7, a specified number of Gabor filters that are experimentally determined to rably affect the performance of the face recognition apparatus are chosen from among a of Gabor filters, and the Gabor filter unit 720 may be allowed to use only the chosen filters. A method of choosing a specified number of Gabor filters from a plurality of Gabor ccording to the Gaussian width-aspect ratio pairs of the Gabor filters will hereinafter be ed in detail with reference to Table 2 and FIG. 11.

TABLE 2

| Gabor Filter No. | (Gaussian Width, Aspect Ratio) |
|---|---|
| 1 | $( \frac{1}{2} λ , \frac{1}{2} )$ |
| 2 | $( \frac{1}{2} λ , \frac{1}{\sqrt{2}} )$ |
| 3 | $( \frac{1}{2} λ , 1 )$ |
| 4 | $( \frac{1}{2} λ , \sqrt{2} )$ |
| 5 | $( \frac{1}{2} λ , 2 )$ |
| 6 | $( \frac{1}{\sqrt{2}} λ , \frac{1}{\sqrt{2}} )$ |
| 7 | $( \frac{1}{\sqrt{2}} λ , 1 )$ |
| 8 | $( \frac{1}{\sqrt{2}} λ , \sqrt{2} )$ |
| 9 | $( \frac{1}{\sqrt{2}} λ , 2 )$ |
| 10 | (λ, 1) |
| 11 | $( λ , \sqrt{2} )$ |
| 12 | (λ, 2) |

FIG. 11 is a graph illustrating experimental results obtained when choosing four Gabor filters from a total of twelve Gabor filters respectively having twelve Gaussian width-aspect ratio pairs presented in Table 2. In Table 2, λ represents the scale of a Gabor filter, and FIG. 11 illustrates experimental results obtained when a false acceptance rate is 0.001.

Face recognition rate was measured by using the first through twelfth Gabor filters separately, and the results of the measurement are represented by Line 1 of FIG. 11. Referring to Line 1 of FIG. 11, the seventh Gabor filter achieves the highest face recognition rate.

Thereafter, face recognition rate was measured by using each of the first through sixth and eighth through twelfth Gabor filters together with the seventh Gabor filter, and the results of the measurement are represented by Line 2 of FIG. 11. Referring to Line 2 of FIG. 11, the first Gabor filter achieves the highest face recognition rate when being used together with the seventh Gabor filter.

Thereafter, face recognition rate was measured by using each of the second through sixth and eighth through twelfth Gabor filters together with the first and seventh Gabor filters, and the results of the measurement are represented by Line 3 of FIG. 11. Referring to Line 3 of FIG. 11, the tenth Gabor filter achieves the highest face recognition rate when being used together with the first and second Gabor filters.

Thereafter, face recognition rate was measured by using each of the second through sixth, eighth, ninth, eleventh, and twelfth Gabor filters together with the first, second, and tenth Gabor filters, and the results of the measurement are represented by Line 4 of FIG. 11. Referring to Line 4 of FIG. 11, the fourth Gabor filter achieves the highest face recognition rate when being used together with the first, second, and tenth Gabor filters.

In this manner, four Gaussian width-aspect ratio pairs that result in high face recognition rates when being used together can be chosen from the twelve Gaussian width-aspect ratio pairs presented in Table 2. Then, a classifier comprising a Gabor filter unit 720 that only uses Gabor filters corresponding to the chosen 4 Gaussian width-aspect ratio pairs is realized. However, it is to be understood that this is merely a non-limiting example. In general, as the number of Gabor filters used by the Gabor filter unit 720 increases, the degree to which face recognition rate is increased decreases, and eventually, the face recognition rate saturates around a specified level. Given all this, the Gabor filter unit 720 may appropriately determine the number of Gabor filters to be used and Gabor filter parameter values in advance through experiments in consideration of the computing capabilities of a classifier and the characteristics of an environment where the classifier is used.

A similar method to the method of choosing a predefined number of Gabor filters from among a plurality of Gabor filters described above with reference to Table 2 and FIG. 11 can be effectively applied to Gabor filter scale and orientation. In detail, referring to FIG. 10, a scale channel-orientation channel pair comprising a scale channel and an orientation channel that are experimentally determined in advance to considerably affect face recognition rate may be chosen from a plurality of scale channel-orientation channel pairs provided for each of the Gaussian width-aspect ratio pairs or from all the scale channel-orientation channels throughout the Gaussian width-aspect ratio pairs. Then, a classifier comprising a Gabor filter unit 720 that only uses Gabor filters corresponding to the chosen scale channel-orientation channel is realized, thereby achieving high face recognition rates with fewer Gabor filters.

3. Analysis of Skin Texture Features of Face Image

According to the present embodiment, a local binary pattern (LBP) feature extraction method and a Fisher discriminant analysis (FDA) method are used to analyze skin texture features of an input face image. When LBP-based Fisher linear discriminant analysis (FLDA) is used, it is difficult to use a Chi square static similarity adopted by LBP histograms.

In addition, according to the present embodiment, kernel non-linear discriminant analysis also called kernel Fisher discriminant analysis (KFDA) is used. KFDA is an approach that incorporates the advantages of a typical kernel method and FLDA. A non-linear kernel method is used to project input data into an implicit feature space F, and FLDA is performed in the implicit feature space F, thereby creating non-linear discriminant features of the input data.

According to the present embodiment, in order to effectively use LBP-based KFDA, the inner product of two vectors in the implicit feature space F needs to be computed based on a kernel function by using a Chi square static similarity measurement method.

An LBP operator for choosing features of a face image will hereinafter be described in detail. The LBP operator is an effective tool for describing texture information of a face image and for providing grayscale/rotation-invariant texture classification which are robust against grayscale and rotation variations. In order to extract facial features that are robust against illumination variations under average illumination conditions, an LBP operator aims at searching for facial features that are invariable regardless of grayscale variations.

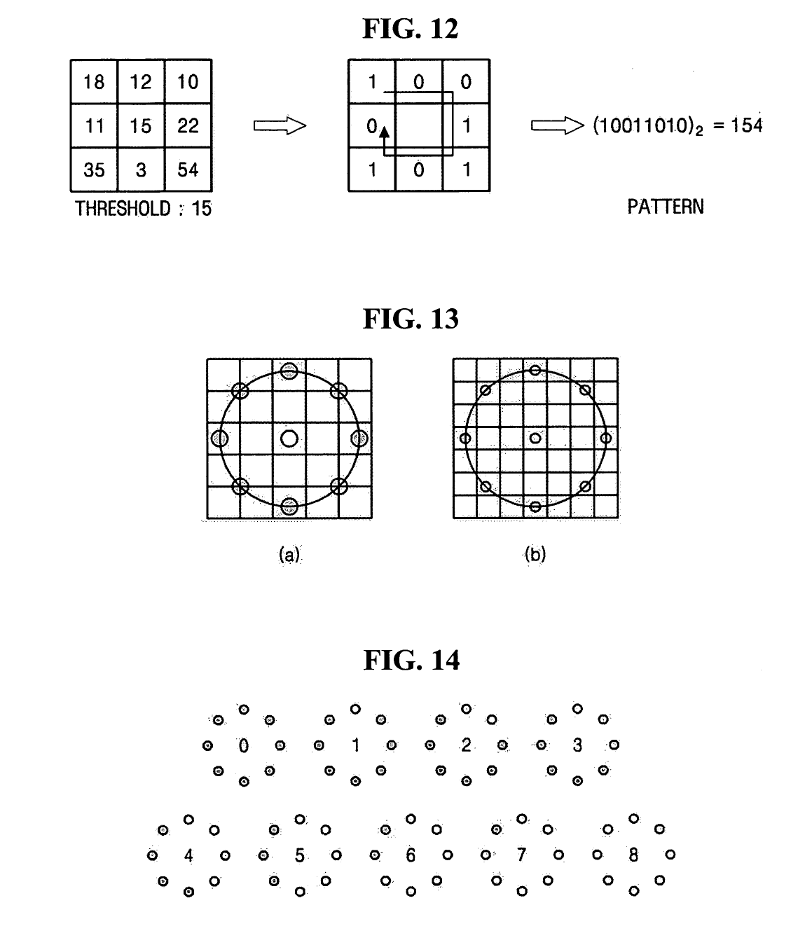

The LBP operator labels a plurality of pixels of an image by thresholding a 3*3 neighborhood of each pixel with a center value and considering the result as a binary number. Then the histogram of the labels can be used as a texture descriptor. FIG. 12 is a diagram for explaining an example of a basic LBP operator.

In order to properly capture large scale structures that may be principal features of a specified texture, the LBP operator was extended to use neighborhoods of different sizes. Using circular neighborhoods and bilinearly interpolating pixel values allows the use of any radius and any number of pixels in the neighborhood. For neighborhoods, the LBP operator uses the notation (P, R) where P represents the number of sampling points present in a circle of radius R. FIGS. 13A and 13B are diagrams for explaining the (P, R) notation. In detail, FIG. 13A illustrates a circular neighborhood for (8, 2) and FIG. 13B a circular neighborhood for (8, 3).

Another extension to the original LBP operator uses so called uniform patterns. An LBP is called uniform if it contains at most two bitwise transitions from 0 to 1 or vice versa when the binary string is considered circular. In detail, Ojala et al. called certain local binary patterns, which are fundamental properties of texture, “uniform,” as they have one thing in common, namely, uniform circular structures that contains very few spatial transitions. Uniform patterns function as templates for microstructures such as bright spots, flat areas or dark spots, and varying positive or negative curvature edges. Ojala et al. noticed that in their experiments with texture images, uniform patterns account for a bit less than 90% of all patterns When using the (8, 1) neighborhood and for around 70% in the (16, 2) neighborhood. This is taught by T. Ojala, M. Pietikainen, and T. Maenpaa in an article entitled “Multiresolution Gray-Scale and Rotation Invariant Texture Classification with Local Binary Patterns.”

FIG. 14 illustrates nine uniform rotation invariant binary patterns. Referring to FIG. 14, the numbers inside the nine uniform rotation invariant binary patterns correspond to their unique LBP_{S,R}^{riu2} codes.

In order to perform an LBP operation for face recognition, T. Ahonen et al. used a non rotation-invariant LBO operator, i.e., LBP_{P,R}^{u2} where subscript PR indicates that the corresponding LBP operator is used in a (P, R) neighborhood, and superscript u2 indicates using only uniform patterns and labeling all remaining patterns with a single label. This is taught by T Ahonen, A. Hadid, and M. Pietikainenin an article entitled “Face Recognition with Local Binary Patterns” and by T Ahonen, M. Pietikainen, A. Hadid and T. Maenpaa in an article entitled “Face Recognition Based on the Appearance of Local Regions.”

Face descriptors use a histogram of labels. According to the present embodiment, an LBP operator LBP_{8,2}^{u2} is used using the face recognition method suggested by T Ahonen. All LBP values are normalized as 59 bins according to a normalization strategy, and this will hereinafter be described in detail. Referring to FIG. 14, the first through seventh codes have 8 rotation patterns and thus satisfy the following equations: 7*8=56 bins. Plus codes 0 and 8 and other non-uniform patterns are treated as specific bins, thus totaling 59 bins (56+3). A histogram of a labeled image fₗ(x,y) can be defined by Equation (19):

$${H}_{i} = {\sum }_{x , y} I \{ {f}_{l} ( x , y ) = i \} , i = 0 , … , n - 1. \qquad ( 19 )$$

Here, n is the number of different labels produced by the LBP operator, n=59, and

$$I \{ A \} = \{ \begin{matrix}1 , & A is true \\ 0 , & A is false .\end{matrix}$$

This histogram contains information regarding the distribution of local micropatterns such as edges, spots and flat areas, over a whole image. For an efficient face representation, a face image must be divided into regions R₀, R₁, . . . , Rₘ₋₁, thereby obtaining a spatially enhanced histogram Hᵢⱼ defined by Equation (20):

$${H}_{i , j} = {\sum }_{x , y} I \{ {f}_{l} ( x , y ) = i \} I \{ ( x , y ) ∈ {R}_{j} \} , \\ i = 0 , … , n - 1 , j = 0 , … , m - 1. \qquad ( 20 )$$

This histogram effectively describes a face on three different levels of locality: the labels of the histogram contain information regarding patterns on a pixel-level; the labels are summed over a small region to produce information on a regional level; and the regional histograms are concatenated to build a global description of the face.

Face verification is performed by calculating similarities between an input query image and a reference image. A Chi square statistic similarity measurement method was suggested for LBP histograms by Abhonen. The Chi square statistic similarity measurement method is defined by Equation (21):

$${χ}^{2} ( S , M ) = {\sum }_{i} \frac{{( {S}_{i} - {M}_{j} )}^{2}}{{S}_{i} + {M}_{j}} . \qquad ( 21 )$$

Here, S and M are LBP histograms of two images compared with each other. LBP-based face recognition methods can provide excellent FERET test results. However, it is an aspect of the present embodiment to use kernel non-linear discriminant analysis as classifiers having an LBP descriptor and enhance test performance.

FLDA is known in the field of face recognition as an efficient pattern classification method. FLDA achieves a linear projection by maximizing a Fisher discriminant function so that an between-class scatter SB can be maximized and that a within-class scatter SW can be minimized, as indicated by Equation (22):

$$J ( w ) = arg {max}_{w} \frac{{w}^{T} {S}_{B} w}{{w}^{T} {S}_{w} w} . \qquad ( 22 )$$

According to the present embodiment, the performance of LBP algorithms is enhanced using discriminant analysis, as indicated by Equation (22). However, one problem of FLDA is associated with difficulty in using the Chi square statistic similarity measurement method for LBP histograms.

Another problem of FLDA is associated with linear representations. FLDA is not appropriate for describing complicated non-linear facial transformations caused by facial expression and illumination variations. According to Cover's theorem on the separability of patterns, nonlinearly separable patterns in an input space can be linearly separated with high probabilities when being converted to a high-dimensional feature space. Also, kernel non-linear discriminant analysis combines the kernel trick and FLDA. At this time, FLDA creates nonlinear discriminant features of input data when being performed in the implicit feature space F, and this type of discriminant analysis is referred to as kernel Fisher discriminant analysis (KFDA).

According to the present embodiment, the performance of face recognition is improved by using LBP-based KFDA. In order to utilize the advantages of the Chi square statistic similarity measurement method for LBP histograms, traditional KFDA may be appropriately modified. KGDA can address the problem of KLDA associated with the implicit feature space F which is established by nonlinear mapping, as indicated by Equation (23):
φ: x∈R^{N}→φ(x)∈F (23)
Here, φ represents an implicit feature vector which does not have to be precisely calculated. Instead, the inner product of two feature vectors in the implicit feature space F which has a kernel function needs to be calculated, as indicated by Equation (24):
k(x,y)=(φ(x)·φ(y)) (24).

Assuming that x represents an input set vector comprising n elements and C classes and nᵢ represents the number of samples, the mapping of an i-th input vector xᵢ may be represented by Equation (25):
φᵢ=φ(xᵢ) (25).

FLDA is performed in order to maximize a Fisher discriminant function defined by Equation (26):

$$J ( w ) = arg {max}_{w} \frac{{w}^{T} {S}_{B}^{ϕ} w}{{w}^{T} {S}_{W}^{ϕ} w} . \qquad ( 26 )$$

Here S_{B}^{φ} and S_{W}^{φ} respectively represent a between-class scatter and a within-class scatter in the implicit feature space F. The between-class scatter S_{B}^{φ}and the within-class scatter S_{W}^{φ}may be represented by Equation set (27):

$${S}_{B}^{ϕ} = {\sum }_{i = 1}^{C} ( {u}_{i} - \overline{u} ) ( {( {u}_{i} - \overline{u} )}^{T} \\ {S}_{W}^{ϕ} = {\sum }_{i = 1}^{C} \frac{1}{{n}_{i}} {\sum }_{j = 1}^{{n}_{i}} ( {ϕ}_{j} - {u}_{i} ) {( {ϕ}_{j} - {u}_{i} )}^{T} \\ Here , {u}_{i} = \frac{1}{{n}_{i}} {\sum }_{j = 1}^{{n}_{i}} {ϕ}_{j} , and \overline{u} = \frac{1}{n} {\sum }_{i = 1}^{n} {ϕ}_{i} . \qquad ( 27 )$$

w (where w∈F) in Equation (26) can be represented by a linear combination, as indicated by the following equation:

$$w = {\sum }_{i = 1}^{n} {α}_{i} {φ}_{i} .$$

Accordingly, Equation (26) can be rearranged into Equation (28):

$$J ( α ) = arg {max}_{α} \frac{{α}^{T} {K}_{B} α}{{α}^{T} {K}_{W} α} . \qquad ( 28 )$$

The problem with KGDA turns into searching for a leading eigenvector of K_{W}⁻¹K_{B}, as indicated by Equation set (29):

$${K}_{B} = {\sum }_{i = 1}^{C} ( {m}_{i} - \overline{m} ) {( {m}_{i} - \overline{m} )}^{T}$$

$${K}_{W} = {\sum }_{i = 1}^{C} \frac{1}{{n}_{i}} {\sum }_{j = 1}^{{n}_{i}} ( {ζ}_{j} - {m}_{i} ) {( {ζ}_{j} - {m}_{i} )}^{T} .$$

Here, ζ=(k(x₁, xⱼ), . . . , k(xₙ,xⱼ))^{T},

$${m}_{i} = {( \frac{1}{{n}_{i}} {\sum }_{j = 1}^{{n}_{i}} k ( {x}_{i} , {x}_{j} ) , \frac{1}{{n}_{i}} {\sum }_{j = 1}^{{n}_{i}} k ( {x}_{2} , {x}_{j} ) , … , \frac{1}{{n}_{i}} {\sum }_{j = 1}^{{n}_{i}} k ( {x}_{n} , {x}_{j} ) )}^{T} ,$$

and m̅ represents the mean of ζⱼ.

Three classes of kernel functions, i.e., a Gaussian kernel, a polynomial kernel, and a sigmoid kernel, are widely used. The Gaussian kernel, the polynomial kernel, and the sigmoid kernel are respectively represented by Equations (30), (31), and (32):

$$\begin{matrix}k ( x , y ) = exp ( - \frac{{‖ x - y ‖}^{2}}{2 {σ}^{2}} ) ; & ( 30 ) \\ k ( x , y ) = {( x \cdot y )}^{d} ; and & ( 31 ) \\ k ( x , y ) = tanh ( κ ( x \cdot y ) + ϑ ) . & ( 32 )\end{matrix}$$

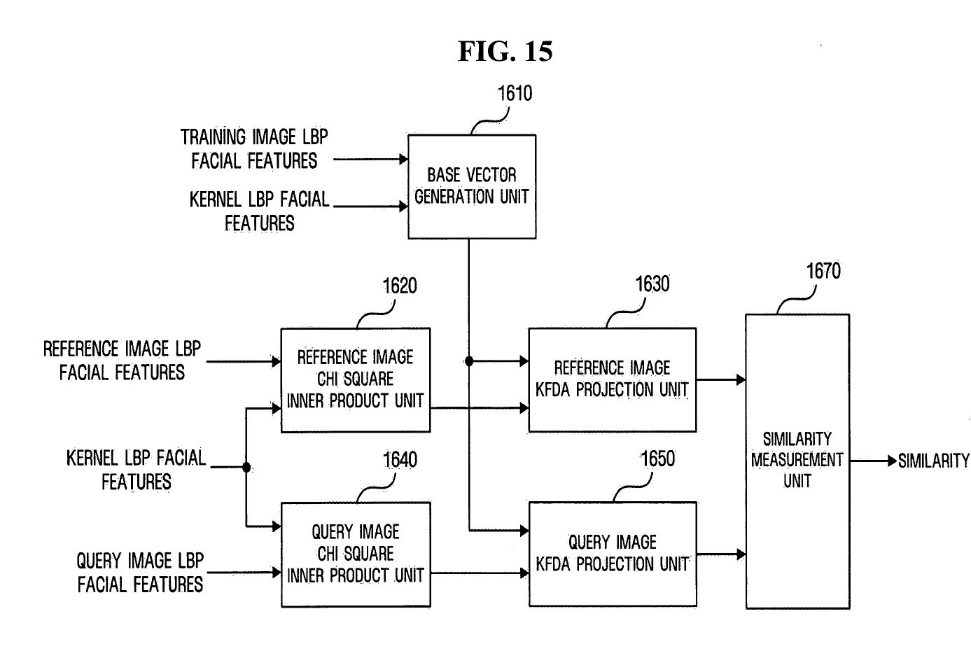

An example of the aforementioned classifier is illustrated in FIG. 15. Referring to FIG. 15, the classifier includes a base vector generation unit 1610, a reference image Chi square inner product unit 1620, a reference image KFDA projection unit 1630, a query image Chi square inner product unit 1640, a query image KFDA projection unit 1650, and a similarity measurement unit 1670.

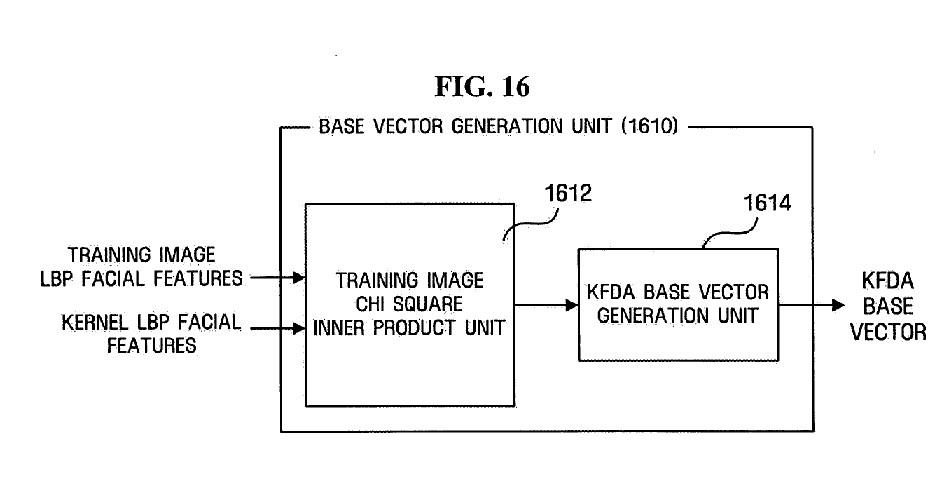

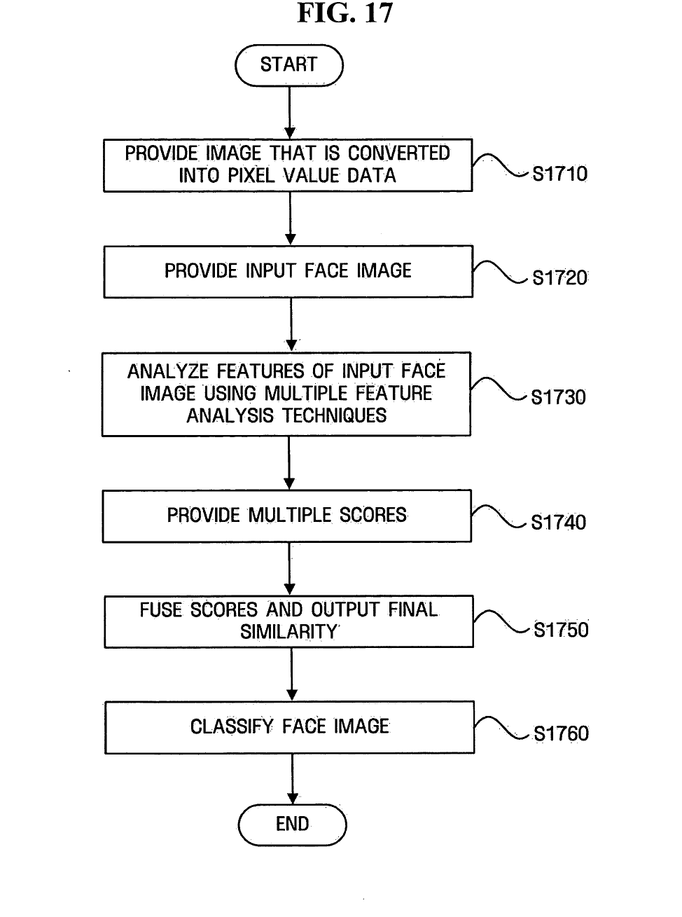

The base vector generation unit 1610 generates a KFDA base vector using LBP features of a face image for training. Referring to FIG. 16, the base vector generation unit 1610 includes a training image Chi square inner product unit 1612 and a KFDA base vector generation unit 1614.

The training image Chi square inner product unit 1612 performs a Chi square inner product operation using LBP facial features of a face image for training and kernel LBP facial features. The LBP facial features of the face image for training may be represented as an LBP histogram by performing an LBP operation on the corresponding face image. The kernel LBP facial features used by the training image Chi square inner product unit 1612 may be a variety of previously registered kernel facial feature vectors that are obtained by performing an LBP operation on several thousands of face images. In short, the training image Chi square inner product unit 1612 creates non-linearly distinguishable patterns using kernel facial feature vectors.

The KFDA base vector generation unit 1614 performs KFDA on the result of the Chi square inner product operation performed by the training image Chi square inner product unit 1612, thereby generating a KFDA base vector. In order to use KFDA having the advantage of LBP algorithms, the Chi square inner product operation may be performed by calculating the inner product of two vectors, as indicated by Equation (33) below. In other words, the inner product of two vectors having different LBP kernel functions in the implicit feature space F can be calculated using the Chi square statistic similarity measurement method.

$$k ( x , y ) = exp ( - \frac{{χ}^{2} ( x , y )}{2 {σ}^{2}} ) . \qquad ( 33 )$$

Here, X²(x,y) is defined by Equation (21). Equation (33) incorporates the advantages of LBP algorithms and the advantages of the Chi square static similarity measurement method.

The reference image Chi square inner product unit 1620 performs a Chi square inner product operation using LBP facial features of a previously registered face image and kernel LBP facial features. The previously registered face image may be represented as a histogram by performing an LBP operation on a reference image. The kernel LBP facial features used by the reference image Chi square inner product unit 1620 are the same as the kernel LBP facial features used by the training image Chi square inner product unit 1612.

The reference image KFDA projection unit 1630 products an LBP feature vector provided by the reference image Chi square inner product unit 1620 onto a KFDA base vector.

The query image Chi square inner product unit 1640 performs the Chi square inner product operation using LBP facial features of a query image and kernel LBP facial features. The kernel LBP facial features used by the query image Chi square inner product unit 1640 are the same as the kernel KBP facial features used by the reference image Chi square inner product unit 1620.

The query image KFDA projection unit 1650 projects an LBP feature vector provided by the query image Chi square inner product unit 1640 onto the KFDA base vector.

The similarity measurement unit 1670 compares a facial feature vector of the reference image, which is generated by the reference image KFDA projection unit 1630, with a facial feature vector of the query image, which is generated by the query image KFDA projection unit 1650, and calculates similarities between the reference image and the query image. The similarities between the reference image and the query image may be calculated according to the Euclidian distance between the facial feature vector of the query image and the facial feature vector of the reference image.

As described above with reference to FIGS. 5 through 16, the classifiers 134 included in the multi-analysis unit 130 can analyze features of an input face image using various feature analysis techniques and can provide similarities regarding the input face image as the results of the analyzing. However, it is to be understood that these described feature analysis techniques used by the classifiers 134 are merely non-limiting examples. Indeed, the classifiers 134 may use a feature analysis technique other than those set forth herein. For example, the classifiers 134 may use various feature analysis techniques such as principal component analysis (PCA), linear discriminant analysis (LDA), independent component analysis (ICA), local feature analysis (LFA), and Gabor wavelet-based approaches which form the basis of face recognition.

The classifier 134 and units included in the face recognition apparatus 100 described above with reference to FIGS. 1 through 16 may be realized as a module. The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

A face recognition method will hereinafter be described in detail with reference to FIG. 17. This method is described with concurrent reference to the apparatus of FIG. 1 for ease of explanation only.

FIG. 17 is a flowchart illustrating a face recognition method according to an embodiment of the present invention. Referring to FIG. 17, in operation S1710, an input image which is converted into pixel value data is provided by the image input unit 110. In operation S1720, the face extraction unit 122 extracts a face image (hereinafter referred to as the input face image) from the input image, and provides the input face image to the multi-analysis unit 130.

In operation S1730, the multi-analysis unit 130 analyzes features of the input face image using a plurality of feature analysis techniques separately. In operation S1740, the multi-analysis unit 130 compares the features of the input face image with features of a reference image, and provides similarities between the features of the input face image and the features of the reference face image.

In detail, in operation S1730, the face image resizing unit 132 of the multi-analysis unit 130 resizes the input face image, thereby providing a plurality of face images that slightly differ from one another in terms of at least one of resolution, scale, and ED and are thus appropriate to be processed by the classifiers 134, respectively. The classifiers 134 use different feature analysis techniques from one another. The analyzing of the features of the input face image and the outputting of the similarities by the classifiers 134 have already been described in detail with reference to FIGS. 4 through 16, and thus, their detailed descriptions will be skipped.

In operation S1750, the multi-analysis unit 130 outputs the similarities, and the fusion unit 140 fuses the similarities output by the multi-analysis unit 130, thereby obtaining a final similarity. A similarity fusion method used by the fusion unit 140 for fusing the similarities output by the multi-analysis unit 130 has already been described above with reference to Equations (1) through (8). However, it is to be understood that this method is merely a non-limiting example and that a similarity fusion method other than the one set forth here may be used to fuse similarities.

In operation S1760, the determination unit 150 compares the final similarity provided by the fusion unit 140 with a specified threshold, thereby classifying the input face image. In detail, the determination unit 150 decides whether to accept or reject the input face image according to the results of the comparison.

According to the above-described embodiments of the present invention, it is possible to provide enhanced face recognition performance by fusing similarities using multiple feature analysis techniques.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A face recognition apparatus comprising:
a multi-analysis unit which analyzes a plurality of features of an input face image using a plurality of feature analysis techniques separately, compares the features of the input face image with a plurality of features of a reference image; and provides similarities as the results of the comparison;
a fusion unit which fuses the similarities; and
a determination unit which classifies the input face image according to a result of the fusion performed by the fusion unit.

2. The face recognition apparatus of claim 1, wherein the fusion unit fuses the similarities by averaging the similarities.

3. The face recognition apparatus of claim 1, wherein the fusion unit fuses the similarities by calculating a weighted sum of the similarities.

4. The face recognition apparatus of claim 3, wherein a weight used in the calculation of the weighted sum of the similarities is an inverse of an equal error rate (ERR) for the feature analysis techniques.

5. The face recognition apparatus of claim 1, wherein the fusion unit fuses the similarities using log-likelihood ratio of the similarities.

6. The face recognition apparatus of claim 5, wherein the fusion unit calculates the similarities according to the following equation:
$${\sum }_{i = 1}^{n} ( \frac{{( {S}_{i} - {m}_{diff , i} )}^{2}}{2 {σ}_{diff , i}^{2}} - \frac{{( {S}_{i} - {m}_{same , i} )}^{2}}{2 {σ}_{same , i}^{2}} ) , and$$
wherein m_{diff,i} is a mean of first similarities obtained from first query image-reference image pairs in learning data using the plurality of feature analysis techniques respectively, the query image and reference image of each first query image-reference image pair rendering different persons, σ_{diff,i} is a standard deviation of the first similarities, m_{same,i} is a mean of second similarities obtained from second query image-reference image pairs in the learning data using the plurality of feature analysis techniques respectively, the query image and reference image of each second query image-reference image pair rendering a same person, σ_{same,i} is a standard deviation of the second similarities, and N is a number of the similarities provided by the a multi-analysis unit.

7. The face recognition apparatus of claim 1, wherein the multi-analysis unit comprises:
a face image resizing unit which resizes the input face image to provide a plurality of face images that differ from one another in at least one of a resolution, a size, and an eye distance (ED); and
a plurality of classifiers which respectively extract the features from the plurality of face image provided by the face image resizing unit by respectively applying the feature analysis techniques, comparing the extracted features with the features of the reference image, and providing the similarities.

8. The face recognition apparatus of claim 7, wherein the multi-analysis unit comprises:
a first classifier which analyzes global features of the input face image;
a second classifier which analyzes local features of the input face image; and
a third classifier which analyzes skin texture features of the input face image.

9. The face recognition apparatus of claim 1, wherein the multi-analysis unit comprises:
a discrete Fourier transform (DFT) unit which performs a two-dimensional (2D) DFT operation on the input face image;
an input vector providing unit which provides an input vector by processing real and imaginary components of a result of the 2D DFT operation and a magnitude of the result of the 2D DFT operation with specified frequency bands;
a linear discriminant analysis (LDA) unit which performs LDA on the input vector; and
a similarity measurement unit which calculates similarities between results of the LDA on the input vector and results of LDA on the reference image by comparing the results of the LDA on the input vector with the results of LDA on the reference image.

10. The face recognition apparatus of claim 9, wherein the input vector providing unit provides the input vector by processing the real and imaginary components of the result of the 2D DFT operation and the magnitude of the result of the 2D DFT operation with different frequency bands.

11. The face recognition apparatus of claim 1, wherein the multi-analysis unit comprises:
a fiducial point extraction unit which extracts at least one fiducial point from the input face image;
a Gabor filter unit which obtains a plurality of response values by respectively applying a plurality of Gabor filters to the fiducial points, the Gabor filters having different properties;
a linear discriminant analysis (LDA) unit which classifies the response values of the plurality of response values into at least one response value group and performs LDA on each of the response value groups;
a similarity measurement unit which calculates similarities between results of the LDA on the at least one response group and results from LDA on the reference image; and
a sub-fusion unit which fuses the similarities.

12. The face recognition apparatus of claim 11, wherein the Gabor filter properties are determined by at least one parameter including at least one of an orientation, a scale, a Gaussian width, and an aspect ratio.

13. The face recognition apparatus of claim 11 further comprising a classification unit which classifies the response values for each of a plurality of Gaussian width-aspect ratio pairs so that a plurality of response values output by a plurality of Gabor filters corresponding to a same orientation are groupable together and that a plurality of response values output by a plurality of Gabor filters corresponding to a same scale are groupable together.

14. The face recognition apparatus of claim 1, wherein the multi-analysis unit comprises:
a base vector generation unit which generates a kernel Fisher discriminant analysis (KFDA) base vector using local binary pattern (LBP) facial features of the input face image;
a reference image Chi square inner product unit which performs a Chi square inner product operation using LBP facial features of a previously registered face image and kernel LBP facial features;
a reference image KFDA projection unit which projects an LBP feature vector provided by the reference image Chi square inner product unit onto the KFDA base vector;
a query image Chi square inner product unit which performs the Chi square inner product operation using the LBP facial features of the input face image and the kernel LBP facial features;
a query image KFDA projection unit which projects an LBP feature vector provided by the query image Chi square inner product unit onto the KDFA base vector; and
a similarity measurement unit which calculates similarities between a query image and a reference image by comparing a reference image facial feature vector provided by the reference image KFDA projection unit with a query image facial feature vector provided by the query image KFDA projection unit.

15. The face recognition apparatus of claim 14, wherein the Chi square inner product operation is performed according to the following equation:
$$k ( x , y ) = exp ( - \frac{{χ}^{2} ( x , y )}{2 {σ}^{2}} ) , and$$
$$wherein$$
$${χ}^{2} ( x , y ) = {\sum }_{i} \frac{{( {x}_{i} - {y}_{i} )}^{2}}{{x}_{i} + {y}_{i}} .$$

16. A face recognition method comprising:
analyzing a plurality of features of an input face image using a plurality of feature analysis techniques separately, comparing the features of the input face image with a plurality of features of a reference image, and providing similarities as results of the comparing;
fusing the similarities; and
classifying the input face image according to a result of the fusing.

17. The face recognition method of claim 16, wherein the fusing comprises averaging the similarities.

18. The face recognition method of claim 16, wherein the fusing comprises calculating a weighted sum of the similarities.

19. The face recognition method of claim 18, wherein a weight used in the calculation is an inverse of an equal error rate (ERR) for the feature analysis techniques.

20. The face recognition method of claim 16, wherein the fusing comprises fusing the similarities using log-likelihood ratio of the similarities.

21. The face recognition method of claim 20, wherein the similarities are calculated according to the following equation:
$${\sum }_{i = 1}^{n} ( \frac{{( {S}_{i} - {m}_{diff , i} )}^{2}}{2 {σ}_{diff , i}^{2}} - \frac{{( {S}_{i} - {m}_{same , i} )}^{2}}{2 {σ}_{same , i}^{2}} ) , and$$
wherein m_{diff,i} is a mean of first similarities obtained from first query image-reference image pairs in learning data using the plurality of feature analysis techniques respectively, the query image and reference image of each first query image-reference image pair rendering different persons, σ_{diff,i} is a standard deviation of the first similarities, m_{same,i} is a mean of second similarities obtained from second query image-reference image pairs in the learning data using the plurality of feature analysis techniques respectively, the query image and reference image of each second query image-reference image pair rendering a same person, σ_{same,i} is a standard deviation of the second similarities, and N is a number of the provided similarities.

22. The face recognition method of claim 16, wherein the providing similarities comprises:
resizing the input face image to provide a plurality of face images that differ from one another in at least one of a resolution, a size, and an eye distance (ED);
extracting the features of the input face image by respectively applying the feature analysis techniques to the face images; and
comparing the extracted features with the features of the reference image, and providing similarities.

23. The face recognition method of claim 22, wherein the extracting comprises:
analyzing global features of the input face image;
analyzing local features of the input face image; and
analyzing skin texture features of the input face image.

24. The face recognition method of claim 16, wherein the providing of the similarities comprises:
performing a two-dimensional (2D) DFT operation on the input face image;
providing an input vector by processing real and imaginary components of the result of the 2D DFT operation and a magnitude of a result of the 2D DFT operation with specified frequency bands;
performing LDA on the input vector; and
calculating similarities between results of the LDA on the input vector and results of LDA on the reference image by comparing the results of the LDA on the input vector with the results of the LDA on the reference image.

25. The face recognition method of claim 24, wherein the providing an input vector comprises providing the input vector by processing the real and imaginary components of a result of the 2D DFT operation and the magnitude of the result of the 2D DFT operation with different frequency bands.

26. The face recognition method of claim 16, wherein the providing similarities comprises:
extracting at least one fiducial points from the input face image;
obtaining a plurality of response values by respectively applying a plurality of Gabor filters to the fiducial points, the Gabor filters having different properties;
classifying the response values of the plurality of response values into at least one response value group and performing a linear discriminant analysis (LDA) operation on each of the response value groups;
calculating similarities between results of the LDA on the response value groups and results of LDA on the reference image; and
fusing the similarities.

27. The face recognition method of claim 26, wherein the Gabor filter properties are determined by at least one parameter including at least one of an orientation, a scale, a Gaussian width, and an aspect ratio.

28. The face recognition method of claim 27, wherein the performing LDA comprises classifying the response values for each of a plurality of Gaussian width-aspect ratio pairs so that a plurality of response values output by a plurality of Gabor filters corresponding to a same orientation are groupable together and that a plurality of response values output by a plurality of Gabor filters corresponding to a same scale are groupable together.

29. The face recognition method of claim 16, wherein the providing similarities comprises:
generating a kernel Fisher discriminant analysis (KFDA) base vector using local binary pattern (LBP) facial features of the input face image;
obtaining a first LBP feature vector by performing a Chi square inner product operation using LBP facial features of a previously registered face image, and kernel LBP facial features, primarily projecting the first LBP feature vector onto the KFDA base vector, obtaining a second LBP feature vector by performing the Chi square inner product operation using the LBP facial features of the input face image and the kernel LBP facial features, and secondarily projecting the second LBP feature vector onto the KDFA base vector; and
calculating similarities between a query image and a reference image by comparing a reference image facial feature vector and a query image facial feature vector that are obtained as the results of the primary projecting and the secondary projecting.

30. The face recognition method of claim 29, wherein the Chi square inner product operation is performed as indicated by the following equation:
$$k ( x , y ) = exp ( - \frac{{χ}^{2} ( x , y )}{2 {σ}^{2}} ) , and$$
$$wherein$$
$${χ}^{2} ( x , y ) = {\sum }_{i} \frac{{( {x}_{i} - {y}_{i} )}^{2}}{{x}_{i} + {y}_{i}} .$$

31. A face recognition method comprising:
separately subjecting features of a query face image to a plurality of feature analysis techniques;
identifying similarities between the features of the query face image and features of a reference face image;
fusing the identified similarities to yield a fused similarity; and
classifying the query face image by comparing the fused similarity to a specified threshold and deciding whether accept or reject the query image based on the comparing.
